(19) United States
(12) Patent Application Publication
(10) Pub. No.: US 2026/0061613 A1
(43) Pub. Date: Mar. 5, 2026

(54) SYSTEM AND METHOD FOR TRAINING AND NAVIGATING A ROBOT

(71) Applicant: ACCENTURE GLOBALL SOLUTIONS LIMITED, Dublin 4 (IE)

(72) Inventors: Ioannis POLYKRETIS, Piscataway, NJ (US); Lavinia Andreea DANIELESCU, Seattle, WA (US)

(73) Assignee: ACCENTURE GLOBALL SOLUTIONS LIMITED, Dublin 4 (IE)

(21) Appl. No.: 19/306,641

(22) Filed: Aug. 21, 2025

Related U.S. Application Data
(60) Provisional application No. 63/689,552, filed on Aug. 30, 2024.

(51) Int. Cl. B25J 9/16

(52) U.S. Cl. CPC B25J 9/1666; B25J 9/163; B25J 9/1661

(57) ABSTRACT

A system and a method for training and navigating a robot in an unmapped environment is disclosed. The method includes, training a movement model for the robot by recording and analyzing movement data of the robot as the robot moves over a plurality of walks within an environment, wherein the training is based on a mixed exploration strategy that incorporates a novelty-based exploration factor into a random exploration strategy, solving a planning task using the movement model, evaluating the movement model based on a planning error that represents a distance between the goal location and a final position reached by the robot on solving the planning task and navigating an unmapped environment including a source and a destination based on actions output by the trained movement model that successfully solves the planning task during the evaluation.

### CROSS-REFERENCE TO RELATED PATENT APPLICATIONS

This application claims priority to U.S. Provisional Application No. 63/689,552, filed on Aug. 30, 2024, the entire content of which is hereby incorporated by reference in the entirety for all purposes.

### TECHNICAL FIELD

The present disclosure generally relates to the field of robotics and, more particularly, to a system and a method for training and navigating a robot in an unmapped environment.

### BACKGROUND

With the advancement of technology, robots are increasingly being deployed in high-risk environments to safeguard human lives. A key challenge in enabling these robots to operate autonomously is navigating through unknown and unmapped terrains. Recent research has explored combining Reinforcement Learning (RL) with Deep Neural Networks (DNNs) to address this challenge, showing promising results. However, the complexity of these learning models often results in a large memory footprint and poses difficulties in adapting them to energy-efficient hardware platforms. For example, RL involves backpropagation, which involves calculating gradients for every parameter in a neural network and this requires strong Central Processing Unit (CPU)/Graphics Processing Unit (GPU), hence a lot of resources. Further, activation and intermediate values, large batch sizes, high resolution inputs, etc., consume a lot of Random Access Memory (RAM)/Video RAM. Furthermore, the backpropagation through time increases memory use because the process stores the entire trajectory (states, actions, rewards, and intermediate computations) for each time step.

Hence, despite the success of RL combined with DNNs in autonomous navigation, their high computational complexity and memory requirements hinder deployment on low-power, resource-constrained robotic systems. There is a need for lightweight and efficient approaches that can enable real-time navigation in unmapped environments without compromising energy efficiency.

### SUMMARY

This summary is provided to introduce a selection of concepts in a simple manner that is further described in the detailed description of the disclosure. This summary is not intended to identify key or essential inventive concepts of the subject matter, nor is it intended for determining the scope of the disclosure.

System and method for training and navigating a robot in an unmapped environment are disclosed. The method includes training a movement model for the robot by recording and analyzing movement data of the robot as the robot moves over a plurality of walks within an environment, wherein the training is based on a, solving a planning task using the movement model, evaluating the movement model based on a planning error that represents a distance between the goal location and a final position reached by the robot on solving the planning task, and navigating an unmapped environment including an source and a destination based on actions output by the trained movement model that successfully solves the planning task during the evaluation.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 illustrates a block diagram of the robot, in accordance with an embodiment of the present disclosure;

FIG. 2 illustrates an exemplary environment and possible directions for movement of the robot, in accordance with an embodiment of the present disclosure;

FIGS. 3A, 3B, 3C and 3D illustrate exemplary visualizations of exploration walks in an environment, in accordance with an embodiment of the present disclosure;

FIG. 4 illustrates exemplary visualizations of exploration walks demonstrating the influence of using different strategies, in accordance with an embodiment of the present disclosure;

FIG. 5 is a flow chart illustrating a method for training and navigating a robot in an unmapped environment, in accordance with an embodiment of the present disclosure; and

FIG. 6 illustrates a computer system that may be used to implement the system disclosed in the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/act involved.

Specific details are provided in the following description to provide a thorough understanding of embodiments. However, it will be understood by one of the ordinary skills in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

To address the one or more limitations described in the background, embodiments of the present disclosure describe a system and method for training and navigating a robot in an unmapped environment. In an embodiment, a movement model is trained for the robot by recording and analyzing movement data of the robot as the robot moves over a plurality of walks within the environment, wherein the walk includes a plurality of steps. To train the model, for each walk, the robot initially identifies available directions of movement for the robot from the current location of the robot and then determines whether to move the robot from the current location in a random direction or a specified direction. Based on the determination, the robot moves either in a random direction or in a specific direction. If the robot decides to move in a specific direction, the robot determines the direction based on the prior movements of the robot. Upon movement, the robot updates the current location as a final location of the robot and repeats the steps by identifying available directions of movement for the robot from the current location of the robot. Hence, the system and method disclosed in the present disclosure uses random exploration strategy and novelty-based exploration strategy during training and enables visitation of unseen locations in the unmapped environments.

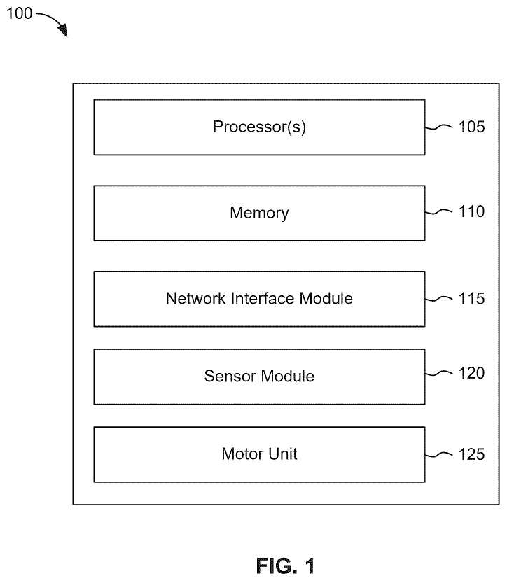

FIG. 1 illustrates a block diagram of the robot, in accordance with an embodiment of the present disclosure. As shown, the robot 100 includes one or more processors 105, a memory module 110, a network interface module 115 enabling communication between the other robots and computing devices, a sensor module 120 and a motor unit 125. It should be noted that the said components may collectively be referred to as a system that enables navigation of the robot 100.

The one or more processors 105 may include a central processing unit (CPU), microprocessors, microcomputers, microcontrollers, digital signal processors, central processing units, state machines, logic circuits, artificial intelligence processors, and/or any devices that manipulate data or signals based on operational instructions. In an embodiment, the one or more processors 105 includes a neuromorphic processor configured to train the robot for movement in unmapped environments. The neuromorphic processor is a type of brain-inspired computer chip which processes information in a way that mimics how the human brain works. The processor allows the robot to perceive, think, learn, and react more efficiently in comparison with the traditional processors. The neuromorphic processor handles spiking neural networks (SNNs) which process data using spikes and enables low-power and real-time processing, parallel computation, and on-chip learning and adaptation. During operation, the processor receives input from the sensor module, translates the input into spikes, trains the movement model and enables the robot to make context-aware decisions based on patterns. Among other capabilities, the processor 105 may fetch instructions (also be referenced to as processor-executable instructions or machine-executable instructions) from the memory 110 and execute the fetched instructions for performing operations according to the present disclosure. The memory 110 may be non-volatile or non-transitory computer-readable medium (CRM) such as, a magnetic disk or solid-state non-volatile memory or volatile medium such as Random Access Memory (RAM), and/or the like.

The sensor module 120 includes one or more specialized sensors and associated circuitry that capture sensory inputs and transmit them to the neuromorphic processor 105, often in the form of spikes (discrete events), enabling event-driven, low-power, and real-time perception. In an embodiment, the sensor module 120 includes sensors such as cameras, dynamic vision sensors (DVS), and Inertial Measurement Units (IMUs). In addition, the sensor module 120 may further include sensors to sense tilt, contact, sound, acceleration, safety, navigation, vision, pressure, force, and location to guide the robot 100 to traverse in the environment.

The motor unit 125 of the robot 100 generates movements by receiving signals from the processor 105 and by converting electrical energy into mechanical energy, allowing the robot 100 to move arms, wheels, joints or the entire body of the robot 100. The motor unit 125 includes one or more motors, motor driver, power source, feedback modules, encoders, etc.

As described, the robot 100, that is the neuromorphic processor 105, initially trains a movement model by recording and analyzing movement data of the robot as the robot 100 moves over a plurality of walks within an environment. The term ‘walk’ as described herein refers to a path including a plurality of steps. In an exemplary embodiment, the walk may be defined by a motion of the robot 100 to cover distance of 10 meters from point A to point B. In another exemplary embodiment, the walk may be defined as a motion of the robot 100 covering a distance within a given time-period, for example, within 2 minutes.

In an embodiment, the processor 105 trains the movement model by recording and analyzing movement data of the robot as the robot 100 moves over a plurality of walks within an environment, wherein each walk includes a plurality of steps, for example from one location to another location in an environment. Considering a single path when the robot 100 is at the initial (current) location, the processor 105 identifies all available directions of movement for the robot 100. In one implementation, the processor 105 uses the input from the camera to identify all possible directions for movement, avoiding obstructions, if any. Since information on the environment may not be readily available, the robot 100 utilizes at least one sensor coupled to the robot 100 to identify the objects that may block the path of the robot 100. Then the processor selects the paths which are free from obstacles.

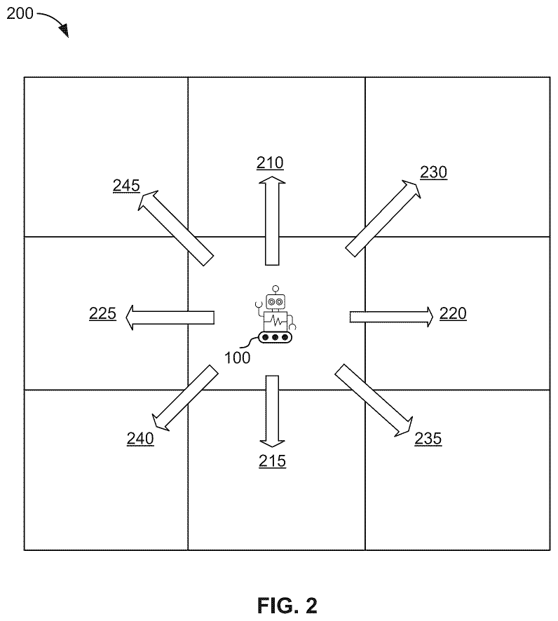

As described, the processor 105 initially identifies all possible paths from its current location. FIG. 2 illustrates an exemplary environment and possible directions for movement of the robot, in accordance with an embodiment of the present disclosure. As shown, the environment 200 is represented as a checkerboard, which may aid in understanding directions for the robotic movements. The robot 100 is illustrated to be in the center of the environment 200. The directions may be implemented as a north or forward direction 210, a south or backwards direction 215, an east or right-ward direction 220, a west or left-ward direction 225, a north-east direction 230, a south-east direction 235, a south-west direction 240, and a north-west direction 245. In this way, when the robot 200 moves forward, the robotic movement may be mapped in the northward direction 210, and when the robot 202 moves backward, the robotic movement may be mapped in the southward direction 215. Similarly, the other directions may be mapped on observing the movements of the robot 100.

Upon identifying possible directions, the robot 100 navigates based on a mixed exploration strategy, which includes random exploration and novelty-based exploration. The mixed exploration strategy may be determined based on novelty as well as randomness. That is, upon identifying all possible paths, the processor 105 determines whether to move the robot 100 from the current location in a random direction or a specific direction. In an embodiment, the processor 105 determines whether to move the robot 100 in a random direction or the specific direction based on a number of completed walks. In one implementation, the processor 105 selects a movement in a random direction if the number of completed walks exceeds a predetermined threshold, for example 10 walks. As the number of completed walks increases, a probability that the robot 100 implements the random movement from the current location in the random direction increases. Hence, the robot 100 uses random exploration to avoid getting stuck in local optima or repetitive paths and balances between exploration (random) and exploitation (specific) that shifts over time. As the robot 100 walks more, the robot 100 becomes more likely to move in random directions instead of following novelty-based deterministic paths. This helps the robot 100 gradually explore the environment more freely over time. If the processor 105 selects a movement in a random direction, then the processor 105 causes a movement of the robot 100 in the random direction from the available directions of movement and collects the observation at the new location and updates a high-dimensional state space embedding. In an embodiment, Cognitive Map Learner (CML) architecture, which encodes the environment over time and space, is used to build the movement model for the robot 100. The architecture includes a single layer artificial neural network (ANN) with a plurality of neurons (nodes) and synaptic connections (edges) between said neurons. In this model, different patterns of activity across the neurons represent various movement states. The network learns transitions (movement from one state to another) automatically through the weights of the synaptic connections. The weights are adjusted during training using real movement data, allowing the ANN to learn how specific inputs (such as sensor readings) lead to changes in movement. Once trained, the ANN takes new input data and use what it has learned to predict the next movement state or generate appropriate control signals to drive motion. In an embodiment, at each exploration step, the processor 105 collects observations of the environment which is represented as:

$${o}_{t} = ( {x}_{i} , {y}_{i} ) ∈ {R}^{{N}_{i}} \qquad Eq ( 1 )$$

Wherein xᵢ,yᵢ are the coordinates of the robot 100 on a 2D plane and the dimension of the observation space is Nᵢ=2. Then the processor 105 creates a high-dimensional state space embeddings sₜ∈R^{N}^{ₛ}, where Nₛ is the dimension of the embedding space. In an embodiment, the processor 105 directly feeds the continuous values of the spatial coordinates into the embeddings of the network.

As described, a mixed exploration strategy is used to select the next movement of the robot 100 from a current location, wherein the mixed exploration strategy incorporates a novelty-based exploration factor into a random exploration strategy. In this mixed exploration strategy, a novelty metric is defined as below:

$$ρ ( x ) = {\sum }_{i = 1}^{k} {d}_{Eu} ( x , {n}_{i} ) \qquad Eq . ( 2 )$$

The metric of Equation (2) quantified the Euclidean distance d_{Eu} between a location x and its k nearest neighbors nᵢ in the set of previously visited locations. In an embodiment k is set to 5. With this method, instead of selecting actions entirely at random, the exploration strategy prioritizes actions that moved the robot 100 to locations that maximized this novelty metric, aiming to emphasize visits to new, unseen parts of the environment.

In an embodiment, to balance between the novelty-driven visitation of unseen locations and the effect learning of the location navigation dynamics from the random exploration strategy, the impact of the novelty-based factor is gradually diminished in the first Nₑₓₚₗ exploratory walks, transitioning to purely random strategy in the latter walks. To balance the two strategies in the in first Nₑ walks, an exploration threshold tₑₓₚₗ is defined which is:

$${t}_{expl} = \{ \begin{matrix}1 \\ 0\end{matrix} - ( 1 / {N}_{expl} ) * {i}_{i > {N}_{expl}}^{i \leq {N}_{expl}} \qquad Eq . ( 3 )$$

Wherein the robot's action is selected at each step by comparing it with s˜U(0,1). If the sampled value ‘s’ falls below the threshold tₑₓₚₗ, the processor 105 chooses an action based on the novelty metric, otherwise, the processor 105 selects an action randomly. As the exploration threshold decreases to zero after the initial Nₑₓₚₗ walks, a purely random strategy will be employed during the remaining walks. The mixed exploration strategy guides the robot 100 through a progression, from a purely novelty-based first walks, gradually incorporating random actions during first Nₑₓₚₗ trails, to concluding with a purely random strategy for the remaining walks.

As described, the processor 105 determines whether to move the robot 100 in a random direction or a specific direction. If it determines a specific direction, the direction is determined based on prior movements of the robot 100. The specific direction brings the robot 100 to the final location that is at a maximum distance from up to a predetermined number of most recent prior locations of the robot 100. This enables the robot 100 to avoid previously visited areas and explore new or unvisited regions, which are based on historical visits. Once the processor 105 moves robot 100 from its current location to the immediate next location, the processor 105 updates the current location and repeats the steps of identifying possible locations, determines whether to move the robot from the current location in a random direction or a specific direction and moves the robot 100 based on determination. These steps are repeated until the robot 100 reaches its destination or until a predetermined criterion is satisfied. The predetermined criterion may be, the time, a predefined number of walks, each walk having a predefined number of steps. It should be noted that the processor 105 collects the observation at each new location (current) and updates the high-dimensional state space embedding of the movement model.

As described, at each exploration step, the processor 105 collects observations of the environment and updates the movement model as shown in equation (1). In an embodiment, when the robot 100 takes an action (when the robot moves from one step to another) αₜϵN_{α}, where N_{α} is the dimension of the action space, the processor 105 generates an estimate of its next state ŝₜ₊∈R^{N}^{ₛ} based on the action taken and the current state. The processor 105 then supervises the performance of the robot 100 by calculating a training error |sₜ∈R^{N}^{ₛ}−ŝ_{t+J}∈R^{N}^{ₛ}|, defined as the distance between its estimated next state and the actual observed state. Using a self-supervised learning rule, the processor 105 computes and updates the CML architecture, which includes three metrices, W_{q}, Wₖ and Wᵥ.

The matrix W_{q}ϵR^{N}^{ₛ}^{×N}^{ᵢ} embeds state observations into the high-dimensional space, WₖϵR^{N}^{_{α}}^{×N}^{ₛ} maps state embeddings sₜ to affordance values gₜ=Sigmoid (Wₖsₜ), which estimate whether an action is available at the current state. Then, WᵥϵR^{N}^{ₛ}^{×N}^{_{α}} maps actions to estimates of their potential impact on the robot's state. After each update calculation, the process is repeated for a defined number of steps, constituting a training episode, during which the matrix updates accumulate. At the end of each episode, the matrix updates are applied to optimize the CML architecture shown in the equations below:

$${W}_{k} = {W}_{k} + {\sum }_{t = 1}^{T} Δ {W}_{k}^{t} , Δ {W}_{k}^{t} = {l}_{k} ( {α}_{t} - {g}_{t} ) {S}_{t}^{T} \qquad Eq . ( 4 )$$

$${W}_{v} = {W}_{v} + {\sum }_{t = 1}^{T} Δ {W}_{v}^{t} , Δ {W}_{v}^{t} = {l}_{v} ( {s}_{t + 1} - {\hat{s}}_{t + J} ) {α}_{t}^{T} \qquad Eq . ( 5 )$$

$${W}_{q} = {W}_{q} + {\sum }_{t = 1}^{T} Δ {W}_{q}^{t} , Δ {W}_{q}^{t} = {l}_{q} ( {\hat{s}}_{t + J} - {s}_{t + 1} ) {α}_{t + 1}^{T} \qquad Eq . ( 6 )$$

Where

$$Δ {W}_{i}^{t} , i ϵ \{ k , v , q \}$$

are the matrix updates computed after each episode step, and lᵢ, iϵ{k, v, q} are the learning rates for each matrix. In an embodiment, 0.001 learning rate is set for all matrices.

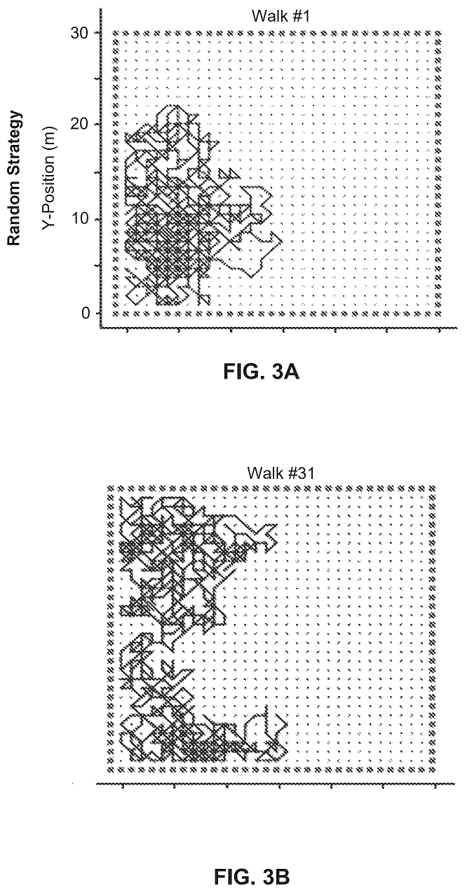

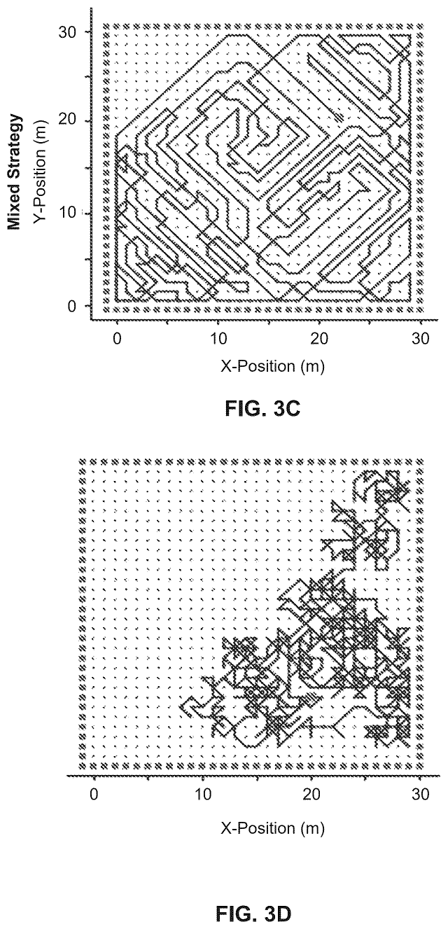

FIGS. 3A, 3B, 3C and 3D illustrate exemplary visualizations of exploration walks in an environment, in accordance with an embodiment of the present disclosure. FIGS. 3A and 3B illustrate visualizations of exploration walks by randomly selected moves in one of the eight possible directions in a 2D grid. This shows that the strategy led to significant repetition of actions in the same locations and resulted in effective learning of navigation policies. FIG. 3C illustrates exemplary visualizations of exploration walks based on purely novelty-based first walks. FIG. 3D illustrates exemplary visualizations of exploration walks when the processor 105 gradually incorporates random actions during first Nₑₓₚₗ trails, to conclude with a purely random strategy for the remaining walks.

As described, for each walk, the processor 105 identifies possible directions from its current location to move to the immediate location, for example from A to A. Then the processor 105 decides to move in one random direction or in a specific direction as described in the present disclosure and moves accordingly. At each step, the processor 105 collects the observation at the new location and updates a high-dimensional state space embedding of the movement model. The processor repeats the steps until the robot 100 reaches its destination or the robot 100 completes the number of steps in each walk and completes the number of walks, which is predefined. That is, the processor 105 repeats the steps at each location, A, A^{|}, A^{∥}, etc. In this way the processor 105 trains the movement model to navigate the robot 100 in any given unmapped environment.

In an embodiment of the present disclosure, upon training the movement model for the robot 100, the model is evaluated by solving a planning task. The robot 100 receives a planning task that includes and sets a goal location to be reached by the robot 100, implements the movement model for solving the planning task and calculates a planning error representing a distance between the goal location set in the planning task and the final position of the robot 100 upon solving the planning task. Based on the planning error, the robot 100 evaluates the movement model for implementation.

Upon receiving the planning task having goal location P_{goal}, the processor 105 embeds the goal into the state space using W_{q}. Then the processor 105 moves the robot 100 to reach the set goal. Upon reaching the final location, a planning error is computed, wherein the planning eₚₒₛ=|P_{goal}−P_{final}| is the distance between the goal and the final position of the robot 100. Upon computing the error, the error value is compared with a predefined threshold and decision is taken to implement the trained model based on a result of comparison. For example, the threshold value may be “5 cm” and if the error is less than 5 cm, then the trained movement model is implanted. In an embodiment, the model is retrained if aggregated behavior insufficient.

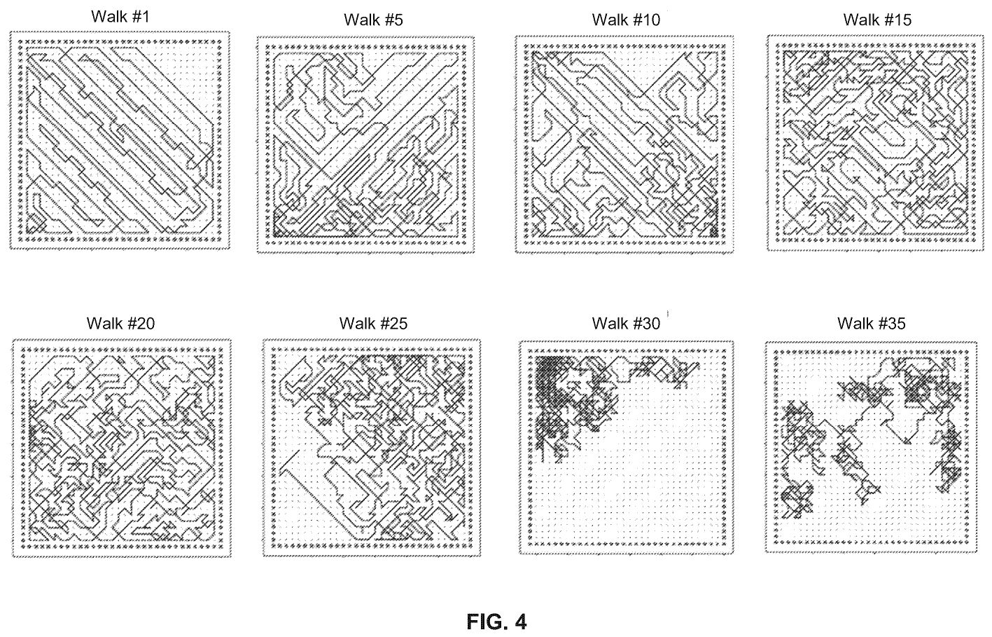

FIG. 4 illustrates exemplary visualizations of exploration walks demonstrating influence of using different strategies, in accordance with an embodiment of the present disclosure. In walk #1, all movements (excluding the first movement) are calculated, and hence the movement pattern is highly organized. In walk #5, 85% of the movements are calculated and 15% of the movements are random, such that the movement pattern of walk #5 is more disordered in comparison with walk #1. In walk #10, 70% of the movements are calculated and 30% of the walks are random, such that walk #10 is more disordered than walk #5. Calculated movements continue to phase out such that by walk #30, very little of the movements (for example, 3%) are calculated and by walk #35, all the robot movements are random.

As described, a movement model is trained for the robot 110, the trained model is evaluated and then implemented to work in the real world, that is to navigate in an unmapped environment.

As described, the robot 100 disclosed in the present disclosure leverages the computational advantages of combining a self-supervised approach with local learning rules on edge hardware. The disclosed training method minimizes the model's embedding space to only encode the robot's position and its action space to a few discrete actions to support navigation. Further, the local learning mitigates the need for backpropagation.

In an embodiment, a method for training and navigating a robot in an unmapped environment is disclosed. The method includes training a movement model for the robot by recording and analyzing movement data of the robot as the robot moves over a plurality of walks within an environment, wherein the training is based on a mixed exploration strategy that incorporates a novelty-based exploration factor into a random exploration strategy, solving a planning task using the movement model, wherein the planning task sets a goal location to be reached by the robot using the trained movement model, and evaluating the movement model based on a planning error that represents a distance between the goal location and a final position reached by the robot on solving the planning task. The method further includes implementing the trained model based on a result of evaluation and navigating an unmapped environment including a source and a destination based on actions output by the trained movement model.

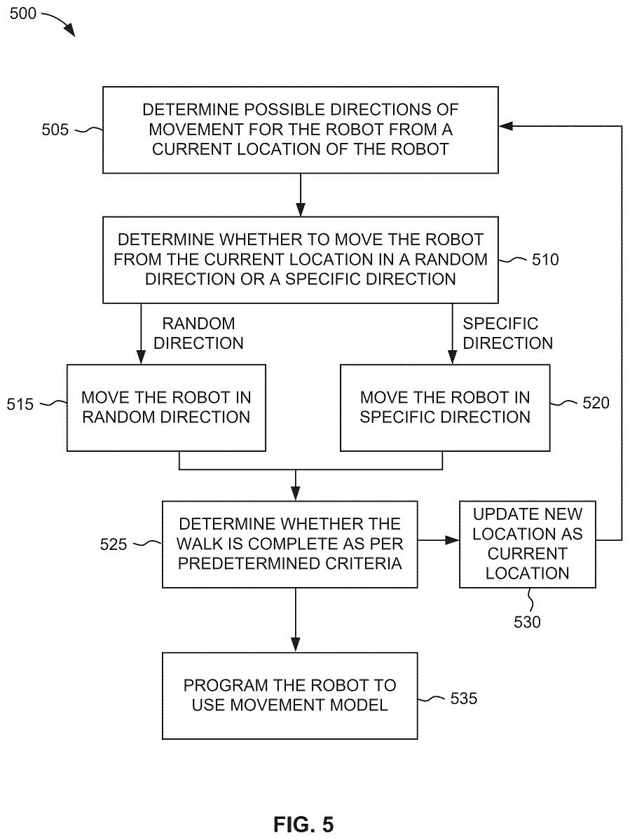

FIG. 5 is a flow chart illustrating a method for training and navigating a robot in an unmapped environment, in accordance with an embodiment of the present disclosure. In an embodiment, during the training stage of the movement model, the robot 100 determines all possible directions of movement for the robot 100 from its current location, as shown at step 505. In an embodiment, the robot 100 uses cameras to capture the surroundings and to detect obstructing objects, if any. Then the robot 100 selects the identifies all possible paths having no obstacles.

At step 510, the robot 100 determines whether to move from its current location in a random direction or a specific direction. That is, the robot 100 navigates based on a mixed exploration strategy, which includes random exploration and novelty-based exploration. The mixed exploration strategy may be determined based on novelty as well as randomness. That is, upon identifying all possible paths, the robot 100 determines whether to move in a random direction or a specific direction based on a number of completed walks. In one implementation, the robot 100 selects a movement in a random direction if the number of completed walks exceeds a predetermined threshold, for example 10 walks. Else, the robot 100 selects to move in a specific direction. It should be noted that this is an example threshold, and other criteria may be implemented as described in the present disclosure with reference to FIG. 1. The robot 100 uses random exploration to avoid getting stuck in local optima or repetitive paths and balances between exploration (random) and exploitation (specific) that shifts over time. As the robot 100 walks more, the robot 100 becomes more likely to move in random directions instead of following a fixed path. This helps the robot 100 gradually explore the environment more freely over time.

If the robot 100 selects a movement in a random direction, then the robot 100 moves in the random direction from the available directions of movement as shown at step 515 and collects the observation at the new location and updates a high-dimensional state space embedding of the movement model. The way in which the model is updated and tuned is described with reference to FIG. 1. If the robot 00 selects to move in a specific direction, then the direction is determined based on the historical visits and moved in the selected direction, as shown at step 520. It should be noted that at each exploration step, the robot updates the movement model. Further, the robot 100 decreases the impact of the novelty-based exploration factor as the robot 100 executes the plurality of walks in the environment.

At step 525, the robot 100 determines whether walk is complete as per predetermined criteria. The predetermined criterion may be the time, reaching the destination, number of steps completed in a walk, the number of walks, etc. If the predetermined criteria are not met, then the robot updates the current location as shown at step 530 and returns to step 505 to find all possible locations considering the new location as its current location. The steps are repeated until all possible paths are explored, the time reaches the predetermined training time or the robot 100 completes a predefined number of walks. Then the robot 100 evaluates the model based on a planning error that represents a distance between the goal location and a final position reached by the robot on solving the planning task. Based on the result of evaluation, the robot is programmed to use the model to operate in an unmapped environment.

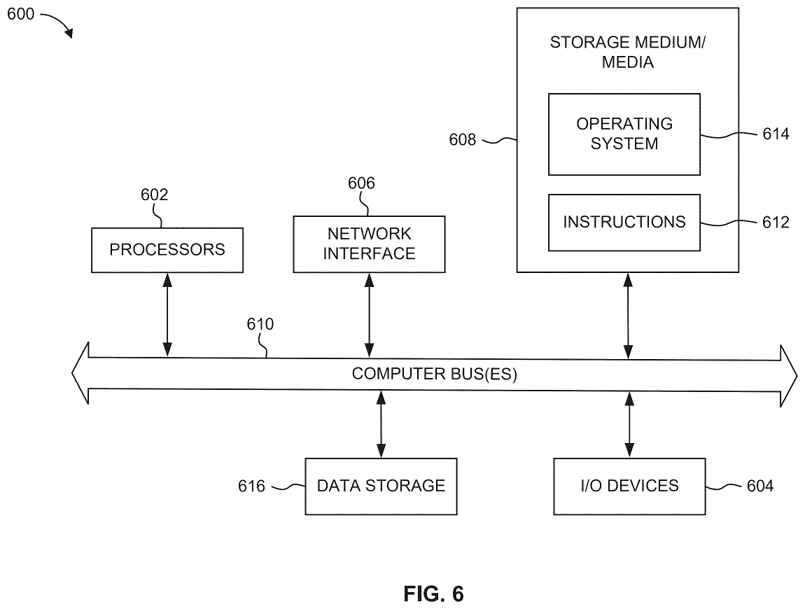

FIG. 6 illustrates a computer system that may be used to implement the system disclosed in the present disclosure. The computer system 600 may include additional components not shown and that some of the process components described may be removed and/or modified. In another example, a computer system 600 may be deployed on external-cloud platforms such as cloud, internal corporate cloud computing clusters, organizational computing resources, and/or the like.

The computer system 600 includes processor(s) 602, such as a central processing unit, ASIC or another type of processing circuit, input/output devices 604, such as a display, mouse keyboard, etc., a network interface 606, such as a Local Area Network (LAN), a wireless 902.11x LAN, a 3G or 4G mobile WAN or a WiMax WAN, and a processor-readable medium 608. Each of these components may be operatively coupled to a bus 610.

The computer-readable medium 608 may be any suitable medium that participates in providing instructions to the processor(s) 602 for execution. For example, the computer-readable medium 608 may be non-transitory or non-volatile medium, such as a magnetic disk or solid-state non-volatile memory or volatile medium such as RAM. The instructions or modules stored on the computer-readable medium 608 may include machine-readable instructions 612 executed by the processor(s) 602 that cause the processor(s) 602 to perform the methods and functions of the system 614.

The system 614 may be implemented as software stored on a non-transitory processor-readable medium and executed by the processors 602. For example, the computer-readable medium 608 may store an operating system 614, such as MAC OS, MS WINDOWS, UNIX, or LINUX, and code for the system 614. The operating system 614 may be multi-user, multiprocessing, multitasking, multithreading, real-time, and the like. For example, during runtime, the operating system 614 is running and the code for the system 614 is executed by the processor(s) 602.

The computer system 600 may include a data storage 616, which may include non-volatile data storage. The data storage 616 stores any data used or generated by the system 115. The network interface 606 connects the computer system 600 to internal systems, for example, via a LAN. Also, the network interface 606 may connect the computer system 600 to the Internet. For example, the computer system 600 may connect to web browsers and other external applications and systems via the network interface 606.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a generic classical processor system and a quantum computing system.

While this specification contains many specific implementation details, these should not be construed as limitations on the scope of what may be claimed, but rather as descriptions of features that may be specific to particular implementations. Certain features that are described in this specification in the context of separate implementations can also be implemented in combination with a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A robot for navigating in an environment, the robot comprising:
a processor, and
a memory storing instructions, that when executed by the processor cause the processor to perform operations comprising:
training a movement model for the robot by recording and analyzing movement data of the robot as the robot moves over a plurality of walks within an environment, wherein a walk includes a plurality of steps and for each of the walks, the processor:
identifies available directions of movement for the robot from a current location of the robot,
wherein the available directions of movement avoid obstructions to robot movements in the environment;
determines whether to move the robot from the current location in a random direction or a specific direction;
causes a movement of the robot in a random direction from the available directions of movement in response to the determination to move the robot from the current location in the random direction;
calculates the specific direction in response to the determination to move the robot from the current location in the specific direction,
wherein the specific direction is calculated based on prior movements of the robot;
causes a specific movement of the robot in the specific direction in response to the calculation of the specific direction; and
updates the current location to a final location of the robot upon completion of the random movement or the specific movement; and
returns to identifying the available directions until a predetermined criterion is satisfied.

2. The robot of claim 1, wherein the instructions to determine whether to move the robot from the current location in the random direction or the specific direction further cause the processor to:
determine whether to move the robot from the current location in the random direction or the specific direction based on a number of completed walks,
wherein, as the number of completed walks increases, a probability that the robot implements the random movement from the current location in the random direction increases.

3. The robot of claim 2, wherein the robot implements the random movement from the current location in the random direction when the number of completed walks exceeds a predetermined threshold.

4. The robot of claim 1, wherein instructions for calculating the specific directions when executed by the processor, cause the processor to:
select the specific direction that will bring the robot to the final location that is at a maximum distance from up to a predetermined number of most recent prior locations of the robot.

5. The robot of claim 1, wherein the memory stores instructions that cause the processor to:
receive a planning task that sets a goal location to be reached by the robot;
implement the movement model in solving a planning task; and
calculate a planning error representing a distance between the goal location set in the planning task and a final position of the robot upon solving the planning task.

6. The robot of claim 5, wherein the memory stores instructions that cause the processor to:
evaluate the movement model for implementation by the robot based on the planning error.

7. The robot of claim 6, wherein the memory stores instructions that cause the processor to:
navigate an unmapped environment based on actions output by the trained movement model that successfully solves the planning task during the evaluation with the planning error being zero.

8. The robot of claim 7, wherein the memory stores instructions that cause the processor to:
operate the movement model in one of a training mode and an inferencing mode.

9. The robot of claim 1, wherein the movement model comprises a single layer artificial neural network (ANN) configured to represent movement states through neural activity and to learn transitions between the states based on weighted connections.

10. The robot of claim 9, wherein the processor is a neuromorphic processor.

11. A processor-executable method for navigation of a robot comprising:
training, by the processor, a movement model for the robot by recording and analyzing movement data of the robot as the robot moves over a plurality of walks within an environment, wherein the training is based on a mixed exploration strategy that incorporates a novelty-based exploration factor into a random exploration strategy;
solving, by the processor, a planning task using the movement model,
wherein the planning task sets a goal location to be reached by the robot using the trained movement model;
evaluating, by the processor, the movement model based on a planning error that represents a distance between the goal location and a final position reached by the robot on solving the planning task; and
navigating, by the processor, an unmapped environment including a source and a destination based on actions output by the trained movement model that successfully solves the planning task during the evaluation.

12. The processor-executable method of claim 11, wherein training the movement model based on the mixed exploration strategy further comprises:
identifying, by the processor, available directions of movement for the robot from a current location of the robot in the environment,
wherein the available directions avoid obstructions to robot movements; and
determining, by the processor, whether to move the robot from the current location in a random direction or a specific direction from the available directions.

13. The processor-executable method of claim 12, wherein training the movement model based on the mixed exploration strategy further comprises:
causing, by the processor, a random movement of the robot in the random direction from the available directions of movement in response to the determination to move the robot from the current location in the random direction; and
causing, by the processor, a specific movement of the robot in a specific direction from the available directions of movement in response to the determination to move the robot from the current location in the specific direction.

14. The processor-executable method of claim 13, wherein causing the specific movement of the robot in the specific direction further comprises:
calculating, by the processor, the specific direction based on the novelty-based exploration factor that configures the specific direction for faster visitation of unseen locations by the robot in the environment.

15. The processor-executable method of claim 13, wherein training the movement model based on the mixed exploration strategy further comprises:
updating, by the processor, the current location of the robot to a final location of the robot upon completion of the random movement or the specific movement; and
returning, by the processor, to a step of identifying the available directions until a predetermined criterion is satisfied.

16. The processor-executable method of claim 15, wherein training the movement model based on the mixed exploration strategy further comprises:
decreasing gradually, by the processor, impact of the novelty-based exploration factor as the robot executes the plurality of walks in the environment.

17. The processor-executable method of claim 11, wherein navigating the unmapped environment further comprises:
selecting, by the processor, a direction that will bring the robot from a current position of the robot closer to a destination in the unmapped environment
wherein the direction is selected from available directions of movement of the robot;
executing, by the processor, a movement by the robot in the selected direction; and
updating, by the processor, the current position of the robot to a new position reached by the robot at an end of the movement in the selected direction.

18. The processor-executable method of claim 11, wherein selecting the direction further comprises:
estimating, by the processor, probabilities for the available directions of movement for the robot to reach the destination in the unmapped environment;
identifying, by the processor, that one of the available directions associated with a highest probability is blocked; and
selecting, by the processor, a next one of the available directions associated with a penultimate highest probability for navigation of the robot upon determining that the next available direction is not blocked.

19. A non-transitory processor-readable storage medium comprising processor-readable instructions that cause a processor to:
train a movement model for a robot by recording and analyzing movement data of the robot as the robot moves over a plurality of walks within an environment, wherein for each of the walks the processor:
identifies available directions of movement for the robot from a current location of the robot,
wherein the available directions avoid obstructions to robot movements in the environment;
determines whether to move the robot from the current location in a random direction or a specific direction;
causes a random movement of the robot in the random direction from the available directions of movement in response to the determination to move the robot from the current location in the random direction;
calculates the specific direction in response to the determination to move the robot from the current location in the specific direction,
wherein the specific direction is obtained based on prior movements of the robot;
causes a specific movement of the robot in the specific direction in response to the calculation of the specific direction; and
updates the current location of the robot to a final location of the robot upon completion of the random movement or the specific movement; and
return to identifying the available directions until a predetermined criterion is satisfied.

20. The non-transitory processor-readable storage medium of claim 19, wherein the processor is a neuromorphic processor and the movement model includes a single layer artificial neural network (ANN) configured to represent movement states through neural activity and to learn transitions between the states based on weighted connections.
